(19) United States
(12) Patent Application Publication
(10) Pub. No.: US 2017/0249606 A1
(43) Pub. Date: Aug. 31, 2017

(54) SYSTEM AND METHOD FOR ELECTRONIC CURRENCY MINING

(71) Applicant: Robert Parviz PIROOZ, Vancouver (CA)

(72) Inventor: Robert Parviz PIROOZ, Vancouver (CA)

(21) Appl. No.: 15/509,806

(22) PCT Filed: Sep. 10, 2015
(86) PCT No.: PCT/CA2015/050875

§ 371 Date: Mar. 8, 2017

Related U.S. Application Data
(60) Provisional application No. 62/048,697, filed on Sep. 10, 2014.

(51) Int. Cl. G06Q 20/06; G06Q 20/02

(52) U.S. Cl. CPC G06Q 20/065; G06Q 20/02

(57) ABSTRACT

A method of distributed mining of an electronic currency is disclosed, including: providing a link to a user member of an organization; receiving a request from the user activating the link, and an agreement from the user to terms of a predetermined electronic currency distribution agreement to mine electronic currency for the organization; receiving a request from the user for an electronic currency mining application; providing the electronic currency mining application to the user; executing the electronic mining application on a user device to mine an electronic currency; receiving mining tracking data from the user; receiving mined electronic currency from an electronic currency server; and distributing a portion of the received electronic currency to the organization according to the predetermined electronic currency distribution agreement.

### 1. CROSS REFERENCE TO RELATED APPLICATIONS

This application is related and claims priority to U.S. Provisional Patent Application Ser. No. 62/048,697 filed Sep. 10, 2014 and entitled “System and Method for Electronic Currency Mining”, which is hereby incorporated herein by reference in its entirety for all purposes.

### 2. TECHNICAL FIELD

The present invention relates generally to systems and methods for electronic currency mining. More specifically, the present invention relates to a system and method for distributed mining and allocation of electronic currency.

### 3. BACKGROUND OF THE INVENTION

Electronic currencies (also referred to as digital currencies), such as crypto currencies and including but not limited to such examples as Bitcoin, Litecoin, Peercoin, and Dogecoin, are typically generated through performance of complex computational tasks by a computer system, commonly referred to as mining of the currency. Through mining of the electronic currency, one or more computer systems may generate data, such as proofs of work, proofs of share, and/or cryptographic encoding, decoding or solution of cryptographic processing blocks, or portions thereof, and be allocated units of an electronic currency by a distributed electronic currency network, where the electronic currency units may be recognized as having economic value by users of the electronic currency. However, as the amounts of electronic currency units assigned for a given quantity of computational work performed decrease according to the unit assignment schemes of various common electronic currency network systems, methods of distributing the mining of electronic currencies between multiple users have become desired.

Further, as the transaction of electronic currencies begins to become more widespread, and valuations of certain electronic currencies has increased relative to traditional cash or sovereign currencies, the ability to donate or contribute to organizations and groups or otherwise distribute units of electronic currencies has become desired.

Accordingly, in view of the above, a need exists for a methods and systems to provide for distributed mining of electronic currencies that may desirably accommodate multiple individuals mining electronic currencies and the distribution of such electronic currencies received for such distributed mining efforts.

### 4. SUMMARY OF THE INVENTION

It is an object of the present invention to provide a method and system for distributed mining of electronic currencies that addresses some of the limitations of the prior art.

Another object of the present invention is to provide a system comprising a computer-readable memory module comprising computer-readable instructions for providing distributed mining of electronic currencies that addresses some of the limitations of the prior art.

It is a further object of the invention to provide a tangible, non-transitory computer-readable storage medium comprising computer-readable instructions for providing distributed mining of one or more electronic currency that addresses some of the limitations of the prior art.

According to an embodiment of the invention, a method of distributed mining of an electronic currency is provided. In such an embodiment, the method comprises executing on at least one computer processor the steps of:

receiving a request from a user electronic device for an electronic currency mining application and an agreement from a user to terms of a predetermined electronic currency distribution agreement;

providing the electronic currency mining application to the user electronic device, wherein the electronic currency mining application comprises a set of computer-readable instructions executable on the user electronic device;

executing the electronic mining application on the user electronic device to mine an electronic currency;

receiving mining tracking data from the user electronic device; and

receiving mined electronic currency from an electronic currency server.

According to a further embodiment of the invention, the method of distributed mining of an electronic currency may further comprise executing on at least one computer processor the step of: distributing a portion of the received electronic currency to a third party according to the predetermined electronic currency distribution agreement.

According to another embodiment of the invention, a method of distributed mining of an electronic currency is provided where the method comprises executing on at least one computer processor the steps of:

providing a link to a user electronic device for a user member of an organization;

receiving from a user electronic device a request from the user activating the link, and an agreement from the user to terms of a predetermined electronic currency distribution agreement to mine electronic currency for the organization;

receiving a request from the user electronic device for an electronic currency mining application;

providing the electronic currency mining application to the user electronic device, wherein the electronic currency mining application comprises a set of computer-readable instructions executable on the user electronic device;

executing the electronic mining application on a user electronic device to mine an electronic currency;

receiving mining tracking data from the user electronic device; and

receiving mined electronic currency from an electronic currency server.

According to a further such embodiment of the invention, the method of distributed mining of an electronic currency may further comprise executing on at least one computer processor the step of: distributing a portion of the received electronic currency to the organization according to the predetermined electronic currency distribution agreement.

According a further embodiment of the invention, a system for distributed mining of an electronic currency is provided, where the system comprises:

one or more network interfaces;

at least one computer processor;

a computer-readable memory module; and

computer-readable instructions stored in the computer-readable memory module, wherein the computer-readable instructions when executed, are operable to configure the at least one computer processor to:

receive a request from a user electronic device for an electronic currency mining application and an agreement from a user to terms of a predetermined electronic currency distribution agreement;

provide the electronic currency mining application to the user electronic device;

execute the electronic mining application on a user electronic device to mine an electronic currency;

receive mining tracking data from the user electronic device; and

receive mined electronic currency from an electronic currency server.

According to a further such embodiment of the invention, the system for distributed mining of an electronic currency may further comprise computer-readable instructions stored in the computer-readable memory module, wherein the computer-readable instructions when executed, are additionally operable to configure the at least one computer processor to distribute a portion of the received electronic currency to a third party according to the predetermined electronic currency distribution agreement.

Further advantages of the invention will become apparent when considering the drawings in conjunction with the detailed description.

### 5. BRIEF DESCRIPTION OF THE DRAWINGS

The system and method of the present invention will now be described with reference to the accompanying drawing figures, in which:

FIG. 1 illustrates a functional block diagram of an exemplary network environment for implementing a computer-implemented embodiment of the present invention.

FIG. 2 illustrates a functional block diagram of an exemplary user device architecture configured according to an embodiment of the invention.

FIG. 3 illustrates a functional block diagram of an exemplary distributed electronic currency mining web server architecture configured according to an embodiment of the invention.

FIG. 4 illustrates an exemplary series of operations associated with an embodiment of the invention.

FIG. 5 illustrates an exemplary series of operations associated with a further embodiment of the invention.

Like reference numerals refer to corresponding parts throughout the several views of the drawings.

### 6. DETAILED DESCRIPTION OF THE INVENTION

In the present application, the term electronic currency is used to describe types of electronically or digitally created and managed currency systems which may also be interchangeably referred to as digital currencies or cryptocurrencies in some references.

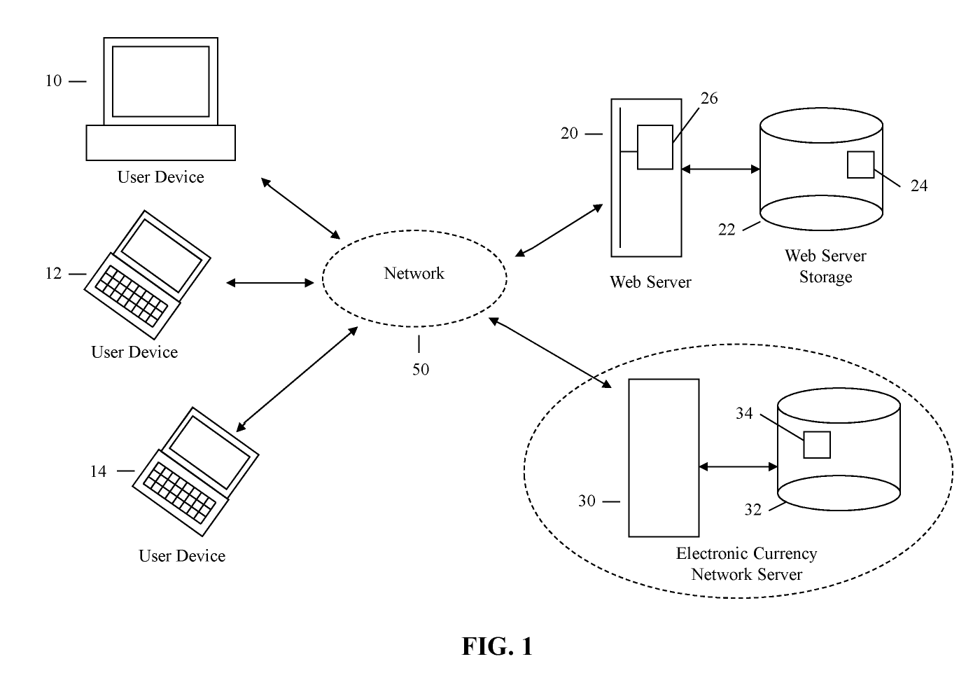

FIG. 1 illustrates a functional block diagram of an exemplary network environment in which computer implemented embodiments of the present invention may be implemented. The networked environment includes one or more user electronic devices, such as user computing devices 10, 12, 14 connected to a communication network 50, which may include one or more of: a local area network, wide area network, world wide web (WWW), or the global Internet, for example, such that user device 10 may communicate with other electronic devices, such as computers and/or computing devices similarly connected to network 50. Other computers connected to network 50 may include an electronic currency mining web server 20, and one or more separate electronic currency network servers 30, which are part of an established distributed electronic currency network, such as but not limited to one or more of the Bitcoin, Litecoin, Peercoin, or Dogecoin electronic currency networks, for example. Typically, each computer connected to network 50 may communicate with any other computer connected to the network 50. User computing devices 10, 12, 14 include standard computing components for transmitting and receiving data to and from other computers connected to the user computing devices 10, 12, 14 through network 50. In one embodiment of the invention, user computing devices 10, 12, 14 may comprise one or more of a: personal computing device such as a desktop computer or terminal 10, a mobile computing device such as a notebook, laptop, netbook or palmtop computer or smartphone device 12, a touchscreen computing device such as a smartphone, tablet or media player computing device 14, or one or more computer server processors (not shown) such as may be employed as a computing server farm or other distributed computer server or processing system or network including cloud processing or cloud server processors or processing providers, for example.

Electronic currency mining web server 20 includes standard computing components for transmitting and receiving data to and from other computers and/or computing devices connected over the network 50, including user devices 10, 12, 14, and optionally also electronic currency network server 30. In particular, electronic currency mining web server 20 includes or is connected to at least one web server storage repository 22 for storing data which may be transmitted or received to or from other computers or computing devices. Such storage repository 22 may comprise a conventional data storage device such as a hard disk or solid-state memory located with and connected directly to electronic currency mining web server 20, or may alternatively comprise a remote data storage repository connected to electronic currency mining web server 20, such as a network storage appliance or separate storage server, or cloud storage service provider, for example.

In one embodiment, electronic currency mining web server 20 may comprise at least one computer readable memory module 26, which may store computer readable instructions or code for implementing functions of the invention, for example. In another embodiment, electronic currency mining web server storage repository 22 may comprise at least one computer readable memory module 24 storing at least one of: computer readable instructions or code for implementing functions of the invention; and data transmitted to and/or received from other computers, such as user data corresponding to one or more electronic currency mining user, electronic currency data corresponding to one or more electronic currency mined or earned by one or more electronic currency mining users, electronic currency distribution data corresponding to distribution of one or more electronic currency mined by one or more users (and/or fiat currency equivalents thereof) between multiple entities based on a predetermined distribution agreement, and system data corresponding to one or more system function, for example. In one such embodiment, system data may comprise at least one of data corresponding to an application or program for mining electronic currency on a user computer or device, and data corresponding to operation of the system such as control, tracking, accounting or commercial data, for example. In an alternative embodiment, such as may be particularly adapted for a small network of devices, web server 20 may comprise a user device such as user device 10, 12 or 14, or alternatively another single or distributed computer processing device (not shown) for example, which may implement the functions and components of a web server 20.

In an optional embodiment of the present invention, electronic currency network server 30 also includes standard computing components for transmitting and receiving data to and from other computers and/or computing devices connected over the network 50, including user devices 10, 12, 14, and electronic currency mining web server 20. In particular, electronic currency network server 30 includes or is connected to at least one electronic currency network storage repository 32 for storing data associated with the mining, transactions, or tracking of one or more electronic currencies, such as but not limited to Bitcoin, Litecoin, Peercoin, Dogecoin, or other electronic or crypto currencies, and which may be transmitted or received to or from other computers or computing devices. Such storage repository may comprise one or more conventional data storage device such as a hard disk or solid-state memory located with and connected directly to electronic currency network server 30, or may alternatively comprise a remote data storage repository 32 connected to electronic currency network server 30, such as a network storage appliance or separate storage server, cloud storage service provider, or preferably a distributed database storage network hosted throughout a distributed network of multiple electronic currency network servers 30, for example.

In one embodiment, electronic currency network server 30 may comprise storage repository 32, which comprises at least one computer readable storage repository module 34, which may store data corresponding to the mining, allocation, ownership and transactions or transfer of electronic currency between users of the currency, such as cryptographic proof of work and timestamping data associated with the mining or creation of electronic currency, hashblocks encoding transactions of electronic currency between users and making up a block chain establishing the basis of the electronic currency, and data associated with other electronic currency network functions, for example.

In another embodiment, an electronic currency network server 30 may also comprise one or more electronic currency mining pools (alternatively known as profit pools), which may comprise at least one storage repository 32, which comprises at least one computer readable storage repository module 34, which may store data corresponding to the mining, allocation, ownership and distribution of units of one or more mined electronic currencies between multiple users or contributors which pool computing resources for mining of the one or more electronic currencies among the currency mining pool users or contributors, for example. In one such embodiment, an electronic currency network server 30 comprising an electronic currency mining pool may be maintained and operated by a third party individual, organization or corporation separate from an operator of the electronic currency web server 20, for example, and the third party electronic currency mining pool may comprise computing resource contributions from the electronic currency web server 20, and from other separate third party computer users, which are combined to provide computing resources for the mining of the one or more electronic currencies operated by the electronic currency mining pool, for example.

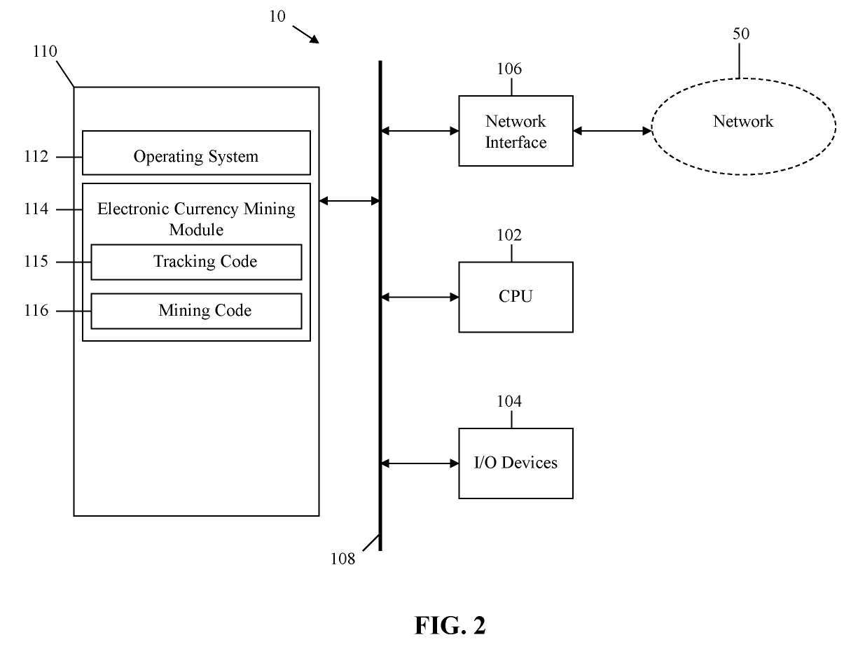

FIG. 2 illustrates a functional block diagram of an exemplary computer architecture for a user device 10 configured in accordance with an embodiment of the invention. The user device 10 may comprise any suitable user computing device such as those described above in reference to FIG. 1, and examples of which include a desktop computer, laptop or other portable computer, tablet computer, mobile device or smartphone, or one or more computer server processors (not shown) such as may be employed as a computing server farm or other distributed computer server or processing system or network including cloud processing or cloud server processors or processing providers, for example. In one embodiment, the user device 10 includes standard computing components, including: a central processor 102, such as a general purpose processor, digital signal processor (DSP), ASIC, FPGA or other programmable logic device or processing device, or cooperating combination of processing devices; and input/output devices 104, which are linked by a bus 108. The input/output devices 104 may comprise a keyboard, buttons, keys, mouse, pointing device, touch screen, monitor, printer, and the like, for example.

A network interface 106 is also connected to the bus 108. The network interface 106 provides connectivity to a network 50, such as the exemplary computer network 50 described above, thereby allowing the user device 10 to operate in a networked environment. Also connected to the bus 108 is a computer-readable memory 110. The memory 110 stores executable instructions to implement functions of the invention. The computer-readable memory 110 may comprise any available computer-readable media or device as may be known in the art that can be accessed by the user device 10, such as but not limited to random access memory (RAM), read only memory (ROM), volatile or non-volatile storage devices, hard disk drives, optical and/or magneto-optical disks, flash memory, magnetic disks, or processor cache or multi-level hierarchical processor cache memories included in processor 102, for example.

In an embodiment of the invention, one or more of the following program modules and data files may be stored in the memory 110 of the user device 10: an operating system module 112, and an electronic currency mining module or application 114.

The operating system module 112 may comprise any known executable operating system instructions, such as may be suitable for controlling the general operations of a networked user device 10, and in particular may comprise instructions for handling various system services, such as file services or for performing hardware dependent tasks. Operating system module 112 may also comprise instructions for standard computer operation, including receiving input from input devices such as a keyboard, touchscreen or mouse, and for displaying output in a graphical format on a monitor, display or touchscreen for example. In particular embodiments, operating system module 112 may comprise one or more known proprietary or open-source computer operating systems, such as for example, Windows™, MacOS™, UNIX™, Linux™, iOS™, Android™, Blackberry™, Symbian™, and Windows Phone™ operating systems.

The exemplary electronic currency mining module or application 114 comprises instructions for communicating with an electronic currency mining web server 20, and optionally also an electronic currency network server 30, over a computer network, to transmit data to and from the user device 10, such as electronic currency mining data, and data associated with allocation of mined or earned units of one or more electronic currencies, to be received by electronic currency mining web server 20. In one embodiment, the electronic currency mining module or application 114 includes exemplary mining code 116 which comprises computer executable instructions for performing computational work associated with mining one or more electronic currencies, such as cryptographic encoding and/or decoding computations associated with mining an exemplary electronic crypto currency according to an embodiment of the present invention. In one embodiment, electronic currency mining module or application 114 may comprise mining code 116 which comprises executable instructions expressed in any suitable format for execution by the electronic currency mining module or application 114 as user device native executable instructions to perform computational work associated with mining one or more electronic currencies, for example. Exemplary such computer executable instructions according to embodiments of the invention are described in further detail below.

In another embodiment, the electronic currency mining module or application 114 includes exemplary tracking code 115 which comprises computer executable instructions for tracking the mining of an electronic currency completed by the user device 10, such as electronic currency units mined or earned and received from an exemplary electronic currency network such as but not limited to Bitcoin, Litecoin, Peercoin, Dogecoin or other electronic currency for example, according to an embodiment of the present invention. In one embodiment, electronic currency mining module or application 114 may comprise tracking code 115 which comprises executable instructions expressed in any suitable format for execution by the electronic currency mining module or application 114 as user device native executable instructions to track units of electronic currency allocated or received for mining performed by the user device, and for assigning such electronic currency units to an electronic currency mining web server 20 for distribution according to the terms of a predetermined distribution agreement, for example. Exemplary such computer executable instructions according to embodiments of the invention are described in further detail below.

The modules stored in memory 110 are exemplary, and additional modules can be included. It should be appreciated that the functions of the presented modules may be combined. In addition, a function of a module need not be performed on a single machine, instead, the function may be distributed across a network to one or more other computers if desired, for example. It is the functions of the invention that are significant, not where they are performed or the specific manner in which they are performed.

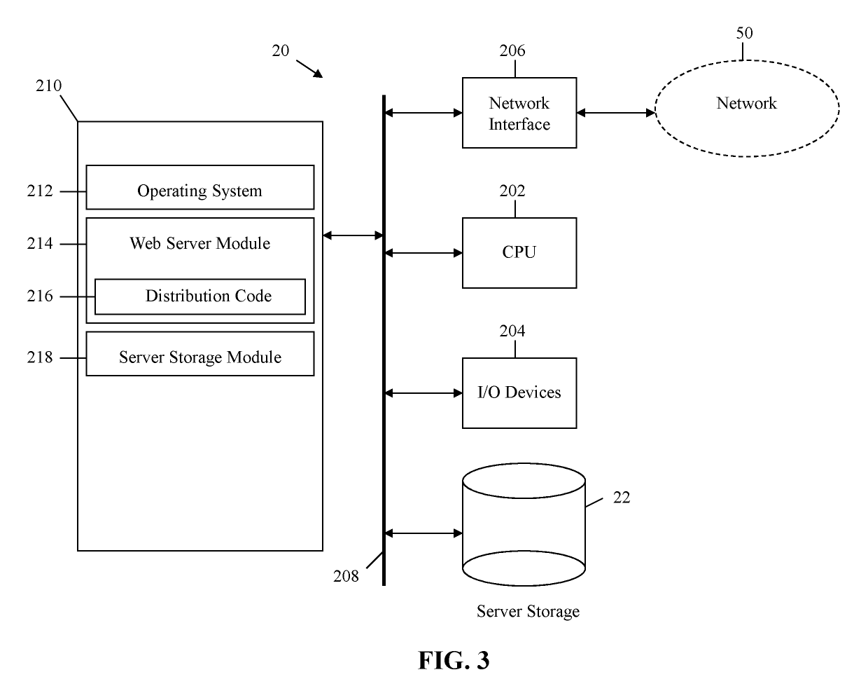

FIG. 3 illustrates a functional block diagram of an exemplary computer architecture for an electronic currency mining web server 20 configured in accordance with an embodiment of the invention. The electronic currency mining web server 20 may comprise any suitable server device and in one embodiment, may include standard computing components, including: a central processor 202, such as a general purpose processor, digital signal processor (DSP), ASIC, FPGA or other programmable logic or processing device, or cooperating combination of processing devices; and input/output devices 204, which are linked by a bus 208. The input/output devices 204 may comprise a keyboard, buttons, keys, mouse, pointing device, touch screen, monitor, printer, and the like, for example.

A network interface 206 is also connected to the bus 208. The network interface 206 provides connectivity to a network, such as the exemplary computer network 50 described above, thereby allowing the web server 20 to operate in a networked environment. Also connected to the bus 208 is at least one computer-readable memory 210. The memory 210 stores executable instructions to implement functions of the invention. The computer-readable memory 210 may comprise any available computer-readable media or device as may be known in the art that can be accessed by the user device 10, such as but not limited to random access memory (RAM), read only memory (ROM), volatile or non-volatile storage devices, hard disk drives, optical and/or magneto-optical disks, flash memory, magnetic disks, or processor cache or multi-level hierarchical processor cache memories included in processor 202, for example.

Electronic currency mining web server 20 also comprises a web server storage repository 22 capable of storing data transmitted to and/or received from other computers, such as user data corresponding to one or more electronic currency mining users, electronic currency mining pool data corresponding to assignment of computing resources of electronic currency mining users to one or more electronic currencies and/or one or more third party electronic currency mining pools, electronic currency data corresponding to electronic currency mined or earned by one or more electronic currency mining user, electronic currency distribution data corresponding to distribution of electronic currency mined by one or more users between multiple entities based on a predetermined distribution agreement, and system data corresponding to one or more system function, for example. In one such embodiment, system data may comprise at least one of data corresponding to an application or program for mining electronic currency on a user computer or device, and data corresponding to operation of the system such as control, tracking, management of third party electronic currency pool participation, electronic currency distribution, accounting or commercial data, for example. In one embodiment, web server storage repository 22 may comprise a conventional data storage device such as a hard disk or solid-state memory located with and connected directly to electronic currency mining web server 20 such as by bus 208 as shown in FIG. 3, or may alternately comprise a remote data storage facility accessibly connected to electronic currency mining web server 20.

In an embodiment of the invention, one or more of the following program modules and data files may be stored in the memory 210 of the electronic currency mining web server 20: an operating system module 212, an electronic currency mining web server module 214, and a web server storage module 218.

Similar to the operating system module described above in reference to FIG. 2, the operating system module 212 may comprise instructions suitable for controlling the general operations of draft server 20, and in particular may comprise instructions for handling various system services, such as file services or for performing hardware dependent tasks. Operating system module 212 may also comprise instructions for standard computer operation, including receiving input from input devices such as a keyboard, touchscreen or mouse, and for displaying output in a graphical format on a monitor, display or touchscreen for example. In particular embodiments, operating system module 212 may comprise one or more known proprietary or open-source computer operating systems, such as, for example, Windows™, MacOS™, UNIX™, Linux™, iOS™, Android™, Blackberry™, Symbian™, Windows Phone™ operating systems.

The exemplary electronic currency mining web server module 214 may comprise instructions for communicating with one or more user devices 10, and optionally also at least one electronic currency network server 30 and/or electronic currency pool server, over a computer network, to transmit data to and from the electronic currency mining web server 20, such as data associated with an electronic currency mining application to be received by user device 10, and tracking, allocation and distribution of mined electronic currency units. In one embodiment, the web server module 214 includes exemplary distribution code 216 which comprises computer executable instructions for implementing a method of distributed electronic currency mining according to an embodiment of the present invention. In one embodiment, web server module 214 may comprise instructions for transmitting an electronic currency mining application, which may comprise an exemplary native or web application, such as an HTML/Javascript/HTML5 web application, to one or more user devices, to be used on multiple user device platforms for execution on the user device 10 to mine one or more electronic currency, for example. In another embodiment, web server module 214 may comprise distribution code 216 which comprises executable instructions expressed in any suitable format for execution by at least one of the web server 20 or a user device 10, to implement a method for distributed mining of electronic currency, for example. Exemplary such computer executable instructions according to embodiments of the invention are described in further detail below.

In one embodiment, memory 210 of electronic currency mining web server 20 may further comprise a web server storage module 218. Web server storage module 218 may comprise executable instructions to communicate with and transmit data to and from a web server storage repository 22, as described above. In such an embodiment, such instructions may comprise computer executable instructions to implement storing of data transmitted to and/or received from other computers, such as user data corresponding to one or more electronic currency mining users, electronic currency mining pool data corresponding to assignment of computing resources of electronic currency mining users to one or more electronic currencies and/or one or more third party electronic currency mining pools, electronic currency data corresponding to electronic currency mined or earned by one or more electronic currency mining user, electronic currency distribution data corresponding to distribution of electronic currency mined by one or more users, and/or portions of one or more other electronic or traditional (fiat) currencies exchanged for electronic currency mined by users, between multiple entities based on a predetermined distribution agreement, and system data corresponding to one or more system function, for example. In one such embodiment, system data may comprise at least one of data corresponding to an application or program for mining electronic currency on a user computer or device or server farm processor, and data corresponding to operation of the system such as control, tracking, management of third party electronic currency pool participation, electronic currency distribution, accounting or commercial data, for example.

The modules stored in memory 210 are exemplary, and additional modules can be included. It should be appreciated that the functions of the presented modules may be combined. In addition, a function of a module need not be performed on a single machine, instead, the function may be distributed across a network to one or more other computers if desired, for example. It is the functions of the invention that are significant, not where they are performed or the specific manner in which they are performed.

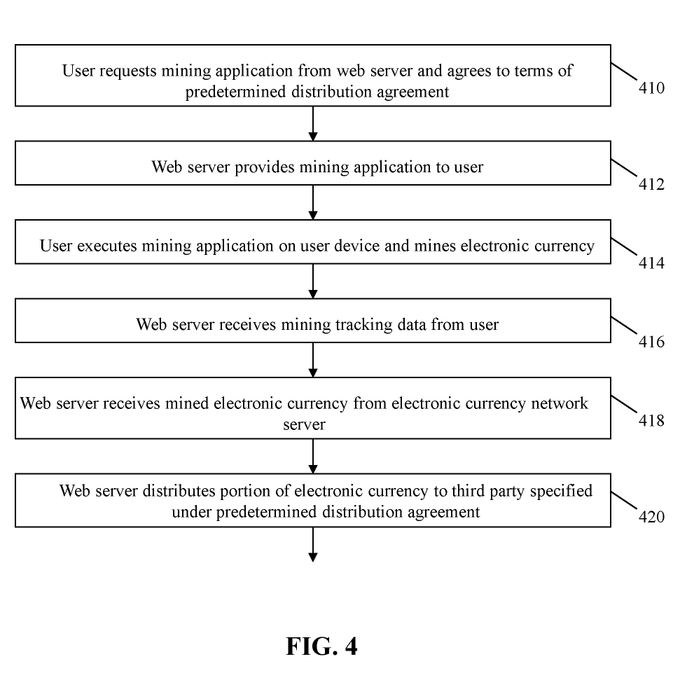

FIG. 4 illustrates an exemplary series of operations that may be implemented by the system illustrated in FIG. 1, and the exemplary user devices 10 illustrated in FIG. 2 and electronic currency mining web server 20 illustrated in FIG. 3, according to an embodiment of the invention. The first operation 410 of FIG. 4 comprises a user requesting an electronic currency mining application from the electronic currency web server, and agreeing to terms of a predetermined electronic currency distribution agreement. The request and agreement from the user device 10 are thereby received by the electronic currency mining web server 20 such as over network 50. In one embodiment, a user may transmit a request for an electronic currency mining application and provide their agreement to the terms of a predetermined distribution agreement for distributing any electronic currency mined by their user device 10 by visiting a web page hosted by the electronic currency mining web server 20, such as through a web browser, and selecting or clicking on an acceptance box to indicate their agreement to the terms of a distribution agreement, for example. In a particular embodiment, a user may agree to terms of a predetermined distribution agreement which specifies the distribution of any electronic currency mined by the user on the user's device 10 between two or more parties. In one such embodiment, the user may identify an organization/group/foundation/charity or other recipient entity to which at least a portion of any electronic currency mined by the user's device 10 is to be distributed, or may select an available entity to receive at least a portion of such mined electronic currency from a list. In such an embodiment, the distribution agreement may preferably specify the distribution of mined electronic currency between the owner or operator of the electronic currency mining server or system and a third party, such as an organization/group/foundation/charity or other entity to which the user is connected, or as selected or specified by the user, such as a charity or other beneficiary organization, for example.

In an alternative embodiment, a user may request an electronic currency mining application from the electronic currency mining web server as an “add-on” or secondary request in combination with a user request for another application or service from a third party web or application server (not shown) or the electronic currency mining web server 20, such as in embodiments where the electronic currency mining application may be provided as part of a set of one or more applications or services of interest to a user, for example. In one such embodiment, a user may request an electronic currency mining application such as by selecting an option as part of a request for another application or service, or by declining to remove a selected option as part of a request for another application or service, which may lead to the electronic currency web server 20 providing the electronic currency mining application to the user in the second operation 412 described in detail below. In another such embodiment, the user may also agree to the terms of a predetermined distribution agreement which specifies the distribution of any electronic currency mined by the user on the user's device 10 between two or more parties, such as by indicating their agreement by selecting an option as part of the request for another application or service or by declining to remove a selected option as part of a request for another application or service. In a further such embodiment, a user may request an electronic currency mining application and/or agree to the terms of a predetermined distribution agreement according to the terms of a previously selected “opt-in” request or selection, or by means of an implied request submitted according to predefined selections or settings configured on a user device 10, and automatically provided to the electronic currency web server 20, such as in response to a user request or agreement being transmitted for another application or service to be provided to the user device 10, for example.

In an alternative embodiment where user devices 10 may comprise one or more server processors and/or cloud processors such as provided by a server farm, the request by the server user device 10 may be initiated by the electronic currency mining web server 20, such as to provide for application to potentially large number of server user devices 10 which may be available from a server farm or cloud computing or other distributed computational resource provider, for example.

The second operation 412 of FIG. 4 comprises the electronic currency mining web server 20 providing an electronic currency mining application to the user. In one such embodiment, an electronic currency mining application is provided to the user device 10 from web server 20 such as over network 50. In a particular embodiment, the electronic currency mining application may comprise exemplary computer executable instructions suitable for execution on a particular user device 10 for performing computational work associated with mining an electronic currency on the user device, such as cryptographic encoding and/or decoding computations associated with mining an exemplary electronic crypto currency, for example. In one embodiment, such computer executable instructions may be expressed in any suitable format for execution by a user device as native executable instructions to perform computational work associated with mining an electronic currency.

In another embodiment, the electronic currency mining application may comprise exemplary computer executable instructions suitable for execution on the user device 10 for tracking the mining of an electronic currency completed by the user device 10, such as electronic currency units mined or earned and received from an exemplary electronic currency network such as but not limited to Bitcoin, Litecoin, Peercoin, Dogecoin or other electronic currency for example, and optionally also for assigning such electronic currency units to an electronic currency mining web server 20 for distribution according to the terms of the predetermined distribution agreement, for example.

In a further embodiment, the electronic currency mining application may comprise exemplary computer executable instructions for specifying an electronic currency type for mining by the user device 10, and further for configuring the user device 10 to mine electronic currency as a contributor of computing resources to one or more third party electronic currency mining pools specified by the electronic currency mining web server 20, for example.

In yet a further embodiment, the electronic currency mining application may also comprise additional desired instructions and/or applications, such as to provide for enhanced security and/or protection against access to the user device 10 by unauthorized outside parties. In such an embodiment, these additional instructions and/or applications may desirably reduce the risk of the user device 10 being successfully targeted by unauthorized malware, virus or other attacks which may disrupt or corrupt the distributed electronic currency mining method without the authorization of the user or the web server 20, for example. In a further such embodiment, the electronic currency mining application may also comprise additional instructions and/or applications such as to provide for updates and/or revisions to the electronic currency mining application to be provided by the web server 20 or other source and to update or revise the operation of the electronic currency mining application on the user device 10. Such updates and/or revisions may be provided to the user device 10, such as to improve performance and/or security of the electronic currency mining application executing on the user device 10, such as by updating instructions to be executed by the user device 10 for specifying a particular type of electronic currency to be mined and associated algorithm to be used for such mining, or for updating instructions to be executed by the user device 10 specifying contribution of user device computing resources to a particular third party electronic currency mining pool, for example.

The third operation 414 of FIG. 4 comprises the user executing the electronic currency mining application on the user device 10 and mining electronic currency. In one embodiment, once installed on the user device 10, the electronic currency mining application may execute substantially automatically on the user device 10 to mine at least one electronic currency, such as by executing computational tasks such as cryptographic encoding/decoding computations associated with mining of an electronic crypto currency, for example. In one such embodiment, the electronic currency mining application may execute automatically in the background of the user device 10 whenever the user device 10 is operating, such as to desirably maximize the amount of electronic currency mined by user device 10.

In another embodiment, the electronic currency mining application may execute on the user device 10 only when the user device is substantially idle and not being used to execute other applications or computational tasks by a user. In yet another embodiment, the electronic currency mining application may automatically determine a relative computational capacity of the user device 10, and then automatically execute using a portion of the computational resources of the user device 10, such as to allow for background execution with a reduced or minimized disruption to other common computational tasks on the user device 10, for example. In yet a further embodiment, the electronic currency mining application may also provide for real-time tracking of computational load on a user device 10, and automatically execute using a portion of the computational resources of the user device 10 determined to be available on a real-time basis for mining electronic currency, such as to desirably reduce any effect of such background mining execution on other uses of the user device 10 by a user, for example. In another embodiment, the electronic currency mining application may also provide for determining a power state of the user device 10, and may automatically execute to reduce or pause electronic currency mining computations when a user device 10 is disconnected from mains electrical power such as when operating on battery power, such as to reduce impact on battery life of the user device 10, for example. In another embodiment, the electronic currency mining application may also provide for monitoring of other computational tasks or software applications executing on a user device 10 (including server processor and/or distributed or cloud processor user devices 10) to detect execution of one or more specific tasks or applications and to provide for instructions to enable automatic execution of the electronic currency mining to mine electronic currency in a background or concurrent execution mode upon detection of such specific tasks or applications on the user device 10.

In a preferred embodiment, the electronic currency mining application also includes instructions which are executable to track the mining of any electronic currency by the mining application on a user device 10, and to store such electronic currency mining tracking data, such as for transmitting to the electronic currency mining web server 20, for example.

The fourth operation 416 of FIG. 4 comprises the electronic currency mining web server 20 receiving electronic currency mining tracking data from a user. In one such embodiment, electronic currency mining tracking data is received by the web server 20 from a user device 10, such as over network 50. In a particular embodiment, electronic currency mining tracking data may be stored by the web server 20, such as in electronic currency mining web server storage repository 22, for example. In another embodiment, the tracking data from a particular user device 10 may also desirably be associated with the terms of the predetermined electronic currency distribution agreement agreed to by the user of the particular user device 10 when the electronic currency mining application was provided to the particular user device 10, for example. In one such embodiment, electronic currency tracking data from a particular user device 10 may comprise data tracking the mining of an electronic currency completed by the particular user device 10, such as electronic currency units mined or earned and allocated or received from an exemplary electronic currency network such as but not limited to Bitcoin, Litecoin, Peercoin, Dogecoin or other electronic currency for example, or for electronic currency units mined or earned and allocated or received from one or more third party electronic currency mining pool. In an optional embodiment, electronic currency tracking data received by the electronic currency mining web server 20 from a particular user device 10 may further comprise data assigning such electronic currency to the electronic currency mining web server 20 for distribution according to the terms of the predetermined distribution agreement agreed to by the user of the particular user device 10, for example.

The fifth operation 418 of FIG. 4 comprises the electronic currency mining web server 20 receiving mined electronic currency from an electronic currency network server 30. In one such embodiment, the mined electronic currency is received by the web server 20 from an electronic currency network server 30 associated with an exemplary electronic currency network such as but not limited to Bitcoin, Litecoin, Peercoin, Dogecoin or other electronic currency for example, over network 50. In one such embodiment, the mined electronic currency received by the web server 20 may comprise units, or portions of units, of electronic currency mined by a particular user device 10 associated with the tracking data received from the user device 10 in operation 416. In another embodiment, the mined electronic currency received by the web server 20 may comprise units, or portions of units, of electronic currency mined by multiple user devices, such as multiple user devices for a particular time period, or all user devices for which a particular predetermined electronic currency distribution agreement has been agreed by the associated users, for example. In an optional embodiment, the mined electronic currency may be received by the web server 20 from one or more third party electronic currency mining pools, and may comprise one or more types of electronic currency, for example. In one such optional embodiment, web server 20 may receive and track electronic currency units from multiple such third party mining pools and may automatically configure one or more user devices 10 to contribute at least a portion of the computing resources of the user device 10 to a particular electronic currency mining pool according to an anticipated or desired return from such mining pool.

In one particular embodiment, the mined electronic currency may comprise an electronic signal or message received by the web server 20 confirming the assignment or transfer of the mined electronic currency to an entity or repository (such as an electronic currency wallet or similar program or repository) designated or controlled by the web server 20, for example. In a further embodiment, at least a portion of the mined electronic currency received by the web server 20 may optionally be converted or exchanged to one or more other electronic or traditional (such as national sovereign or fiat currencies for example) currencies which may be held in accounts on or controlled by the web server 20, for example. In one such embodiment, at least a portion of the mined electronic currency received by the web server 20 may be converted or exchanged to a traditional cash or fiat currency through a currency market or exchange, for example.

The sixth operation 420 of FIG. 4 comprises the electronic currency web server 20 distributing a portion of the received electronic currency to a third party specified under the predetermined electronic currency distribution agreement. In one such embodiment, the third party may comprise the organization/group/foundation or other entity identified by and/or chosen by a user for distribution of a portion of the mined electronic currency mined by the user's device as agreed in the predetermined distribution agreement. In a particular such embodiment, the portion of the mined electronic currency received by the web server 20 to be distributed to a third party as specified by the predetermined distribution agreement for a user or group of user devices may be transferred or assigned to the designated third party on a batch basis, such as on a weekly, monthly, or other periodic basis, or a continuous basis as mined electronic currency is received, as may be specified in the terms of the distribution agreement agreed by the users of the user devices 10 at the time the application was received. In one such embodiment, the remaining portion of the mined electronic currency not transferred to the designated third party may be distributed or transferred/assigned to the owner or operator of the electronic currency mining web server 20, or their designate, for example. In another embodiment, the electronic currency mining tracking data received by the web server 20 in operation 416 may be stored, such as in web server storage repository 22, for a period of time, such as to provide for tracking, accounting and compliance verification with the terms of the predetermined electronic currency distribution agreement, for example.

In a further optional embodiment, similar to as described above, at least a portion of the mined electronic currency received by the web server 20 may optionally be converted or exchanged to one or more other electronic or traditional (such as national sovereign or fiat currencies for example) currencies which may be held in accounts on or controlled by the web server 20, for example. In one such optional embodiment, at least a portion of the electronic currency distributed to the third party in operation 420 may comprise a different electronic currency to that mined by the user(s), and in particular at least a portion of the electronic currency distributed to the third party may comprise a traditional sovereign, fiat or cash currency which may be electronically transferred as an electronic cash currency transfer, and/or transferred as a conventional physical payment such as by cheque, bank draft, physical cash payment, or other negotiable financial instrument, for example.

In another optional embodiment, a portion of the mined electronic currency received by the web server 20 from one or more user devices 10 may be distributed to one or more user device or associated user, such as representing an electronic currency mining participation prize or incentive, for example. In one such optional embodiment, web server 20 may periodically distribute a selected portion of electronic currency (or a selected value in another currency such as fiat or cash currency) mined by a group of user devices 10 to a selected one or several particular user devices 10 or associated users. In one such embodiment, the selected one or several particular user devices 10 or users may be selected randomly, such as in an exemplary case wherein a periodic randomly selected user device 10 or associated user may be allocated a selected portion of electronic currency (or equivalent value) mined by a group of user devices 10 as a monthly (or other periodic) participation lottery, such as to promote participation of users and/or incentivize providing availability of user devices 10 for distributed electronic currency mining according to the above-described systems and methods, for example. In another such optional embodiment, the prize or allocation awarded to a selected one or several particular user devices 10 or associated users may comprise a non-currency prize such as merchandise, vehicle, or service prizes or other suitable incentives, for example.

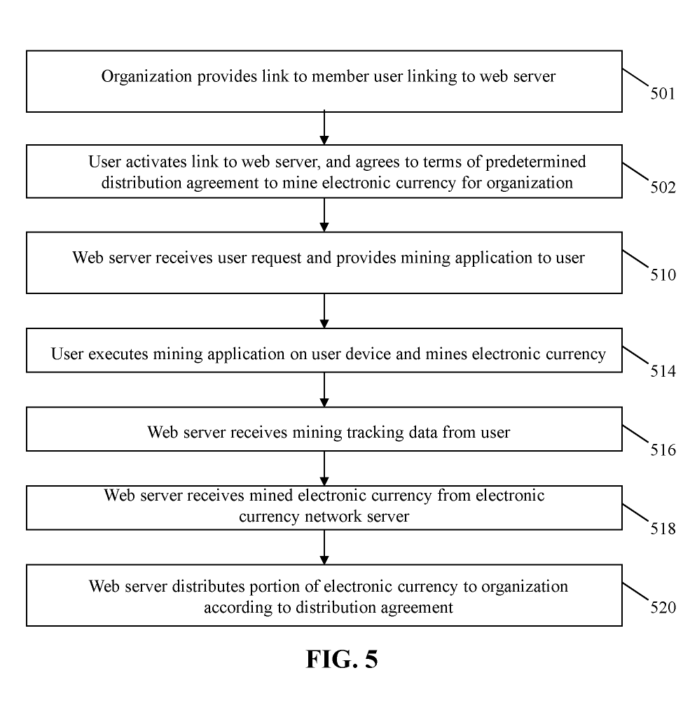

FIG. 5 illustrates an exemplary series of operations that may be implemented by the exemplary system illustrated in FIG. 1, and the exemplary user devices 10 illustrated in FIG. 2 and electronic currency mining web server 20 illustrated in FIG. 3, according to a further embodiment of the invention.

The first operation 501 of FIG. 5 comprises an organization providing a link to a member user linking to the electronic currency mining web server 20. In one embodiment, the organization may comprise any organization/group/foundation and/or charity for example, having multiple members and/or an organizer, leader, owner or facilitator of such an organization/group/foundation/charity. In one such embodiment, the link provided to a member user of the organization and linking to the electronic currency mining web server 20 may comprise any suitable link, bookmark, directions or other means for instructing or encouraging a member user to connect a user device 10 to the electronic currency mining web server 20, such as through network 50. In one such embodiment, the organization may comprise a union, charity, foundation, support group, fan club, club, public interest group, or other organization comprising multiple members. In a particular embodiment, the link may comprise a web link, URL, IP address, or other embedded electronic link instruction, or an electronic message, posting, tweet, or other communication containing such a link, which may be activated by a member user to connect a user device 10 to the electronic currency mining web server 20, such as by visiting a web page hosted by the electronic currency mining web server 20 through a web browser, or other connected application, for example. In another such embodiment, an electronic message, posting, tweet or other communication containing the link may also comprise a message, encouragement, explanation or image, branding, logo or representation associated with or owned by the organization such as to identify the message and link to the member user as being endorsed or approved by the organization, for example.

The second operation 502 of FIG. 5 comprises the user activating the link to electronic currency mining web server 20, and agreeing to the terms of a predetermined distribution agreement to mine electronic currency for the organization. In one such embodiment, the user may navigate to a webpage hosted by the web server 20 and may indicate their agreement to terms of a predetermined electronic currency distribution agreement to mine electronic currency on their user device 10 for the organization, the terms of such distribution agreement having been determined by the organization and owner of web server 20 in advance. In a particular such embodiment, the user may indicate their agreement to the terms of the predetermined electronic currency distribution agreement by selecting or clicking on an acceptance box on the webpage hosted by the web server 20, for example. In one embodiment, the predetermined distribution agreement may specify the distribution of any electronic currency mined by the member user on the user's device 10 between at least the organization and the owner/operator of the web server 20 or their designate, for example.

The third operation 510 of FIG. 5 comprises the electronic currency mining web server 20 receiving a request from a user for an electronic currency mining application and providing an electronic currency mining application to the user device 10. The request from a user device 10 may be received by the electronic currency mining web server 20, and the electronic currency mining application may be provided to the user device 10 over network 50, for example. In one embodiment, a user may transmit a request for an electronic currency mining application for mining electronic currency on their user device 10 for an organization by visiting a web page hosted by the electronic currency mining web server 20, such as through a web browser. In a particular embodiment, the electronic currency mining application may comprise exemplary computer executable instructions suitable for execution on a user device 10 for performing computational work associated with mining an electronic currency on the user device, such as cryptographic encoding and/or decoding computations associated with mining an exemplary electronic crypto currency, for example. In one embodiment, such computer executable instructions may be expressed in any suitable format for execution by user device as native executable instructions to perform computational work associated with mining an electronic currency.

In an alternative embodiment, a user may request an electronic currency mining application from the electronic currency mining web server as an “add-on” or secondary request in combination with a user request for another application or service from a third party web or application server (not shown) or the electronic currency mining web server 20, such as in embodiments where the electronic currency mining application may be provided as part of a set of one or more applications or services of interest to a user, for example. In one such embodiment, a user may request an electronic currency mining application such as by activating a link to another application or service from a third party, by selecting an option as part of a request for another application or service, or by declining to remove a selected option as part of a link or request for another application or service, which may lead to the electronic currency web server 20 providing the electronic currency mining application to the user device 10. In another such embodiment, the user may also agree to the terms of a predetermined distribution agreement which specifies the distribution of any electronic currency mined by the user on the user's device 10 between two or more parties, such as by activating a link or otherwise indicating their agreement by selecting an option as part of the link and/or request for another application or service or by declining to remove a selected option as part of a request for another application or service. In a further such embodiment, a user may request an electronic currency mining application and/or agree to the terms of a predetermined distribution agreement according to the terms of a previously selected “opt-in” request or selection such as may be stored by a cookie or similar setting on a user device 10, or by means of an implied request submitted according to predefined selections or settings configured on a user device 10, and automatically provided to the electronic currency web server 20, such as in response to a user activating a link and/or request being transmitted for another application or service to be provided to the user device 10, for example.

In another embodiment, the electronic currency mining application may comprise exemplary computer executable instructions suitable for execution on the user device 10 for tracking the mining of an electronic currency completed by the user device 10, such as electronic currency units mined or earned and received from an exemplary electronic currency network such as but not limited to Bitcoin, Litecoin, Peercoin, Dogecoin or other electronic currency for example, and optionally also for assigning such electronic currency units to an electronic currency mining web server 20 for distribution according to the terms of the predetermined distribution agreement, for example.

In a further embodiment, the electronic currency mining application may comprise exemplary computer executable instructions for specifying an electronic currency type for mining by the user device 10, and further for configuring the user device 10 to mine electronic currency as a contributor of computing resources to one or more third party electronic currency mining pools specified by the electronic currency mining web server 20, for example.

In yet a further embodiment, the electronic currency mining application may also comprise additional desired instructions and/or applications, such as to provide for enhanced security and/or protection against access to the user device 10 by unauthorized outside parties. In such an embodiment, these additional instructions and/or applications may desirably reduce the risk of the user device 10 being successfully targeted by unauthorized malware, virus or other attacks which may disrupt or corrupt the distributed electronic currency mining method without the authorization of the user or the web server 20, for example. In a further such embodiment, the electronic currency mining application may also comprise additional instructions and/or applications such as to provide for updates and/or revisions to the electronic currency mining application to be provided by the web server 20 or other source and to update or revise the operation of the electronic currency mining application on the user device 10. Such updates and/or revisions may be provided to the user device 10, such as to improve performance and/or security of the electronic currency mining application executing on the user device 10, such as by updating instructions to be executed by the user device 10 for specifying a particular type of electronic currency to be mined and associated algorithm to be used for such mining, or for updating instructions to be executed by the user device 10 specifying contribution of user device computing resources to a particular third party electronic currency mining pool, for example.

The fourth operation 514 of FIG. 5 comprises the user executing the electronic currency mining application on the user device 10 and mining electronic currency. In one embodiment, once installed on the user device 10, the electronic currency mining application may execute substantially automatically on the user device 10 to mine at least one electronic currency, such as by executing computational tasks such as cryptographic encoding/decoding computations associated with mining of an electronic crypto currency, for example. In one such embodiment, the electronic currency mining application may execute automatically in the background of the user device 10 whenever the user device 10 is operating, such as to desirably maximize the amount of electronic currency mined by user device 10.

In another embodiment, the electronic currency mining application may execute on the user device 10 only when the user device is substantially idle and not being used to execute other applications or computational tasks by a user. In yet another embodiment, the electronic currency mining application may automatically determine a relative computational capacity of the user device 10, and then automatically execute using a portion of the computational resources of the user device 10, such as to allow for background execution with a reduced or minimized disruption to other common computational tasks on the user device 10, for example. In yet a further embodiment, the electronic currency mining application may also provide for real-time tracking of computational load on a user device 10, and automatically execute using a portion of the computational resources of the user device 10 determined to be available on a real-time basis for mining electronic currency, such as to desirably reduce any effect of such background mining execution on other uses of the user device 10 by a user, for example. In another embodiment, the electronic currency mining application may also provide for determining a power state of the user device 10, and may automatically execute to reduce or pause electronic currency mining computations when a user device 10 is disconnected from mains electrical power such as when operating on battery power, such as to reduce impact on battery life of the user device 10, for example. In another embodiment, the electronic currency mining application may also provide for monitoring of other computational tasks or software applications executing on a user device 10 (including server processor and/or distributed or cloud processor user devices 10) to detect execution of one or more specific tasks or applications and to provide for instructions to enable automatic execution of the electronic currency mining to mine electronic currency in a background or concurrent execution mode upon detection of such specific tasks or applications on the user device 10.

In a preferred embodiment, the electronic currency mining application also includes instructions which are executable to track the mining of any electronic currency by the mining application on a user device 10, and to store such electronic currency mining tracking data, such as for transmitting to the electronic currency mining web server 20, for example.

The fifth operation 516 of FIG. 5 comprises the electronic currency mining web server 20 receiving electronic currency mining tracking data from a user. In one such embodiment, electronic currency mining tracking data is received by the web server 20 from a user device 10, such as over network 50. In a particular embodiment, electronic currency mining tracking data may be stored by the web server 20, such as in electronic currency mining web server storage repository 22, for example. In another embodiment, the tracking data from a particular user device 10 may also desirably be associated with the terms of the predetermined electronic currency distribution agreement agreed to by the user of the particular user device 10 when the electronic currency mining application was provided to the particular user device 10, and/or the organization to which the user is connected, for example. In one such embodiment, electronic currency tracking data from a particular user device 10 may comprise data tracking the mining of an electronic currency completed by the particular user device 10, such as electronic currency units mined or earned and allocated or received from an exemplary electronic currency network such as but not limited to Bitcoin, Litecoin, Peercoin, Dogecoin or other electronic currency for example, or for electronic currency units mined or earned and allocated or received from one or more third party electronic currency mining pool. In an optional embodiment, electronic currency tracking data received by the electronic currency mining web server 20 from a particular user device 10 may further comprise data for assigning such electronic currency units to the electronic currency mining web server 20 for distribution according to the terms of the predetermined distribution agreement agreed to by the user of the particular user device 10, for example.

The sixth operation 518 of FIG. 5 comprises the electronic currency mining web server 20 receiving mined electronic currency from an electronic currency network server 30. In one such embodiment, the mined electronic currency is received by the web server 20 from an electronic currency network server 30 associated with an exemplary electronic currency network such as but not limited to Bitcoin, Litecoin, Peercoin, Dogecoin or other electronic currency for example, over network 50. In one such embodiment, the mined electronic currency received by the web server 20 may comprise units, or portions of units, of electronic currency mined by a particular user device 10 associated with the tracking data received from the user device 10 in operation 516. In another embodiment, the mined electronic currency received by the web server 20 may comprise units, or portions of units, of electronic currency mined by multiple user devices, such as multiple user devices for a particular time period, or all user devices for which a particular predetermined electronic currency distribution agreement has been agreed by the associated users, or for a particular organization to which the multiple user devices are correlated, for example. In an optional embodiment, the mined electronic currency may be received by the web server 20 from one or more third party electronic currency mining pools, and may comprise one or more types of electronic currency, for example. In one such optional embodiment, web server 20 may receive and track electronic currency units from multiple such third party mining pools and may automatically configure one or more user devices 10 to contribute at least a portion of the computing resources of the user device 10 to a particular electronic currency mining pool according to an anticipated or desired return from such mining pool.

In one particular embodiment, the mined electronic currency may comprise an electronic signal or message received by the web server 20 confirming the assignment or transfer of the mined electronic currency to an entity or repository (such as an electronic currency wallet or similar program or repository) designated or controlled by the web server 20, for example. In a further embodiment, at least a portion of the mined electronic currency received by the web server 20 may optionally be converted or exchanged to one or more other electronic or traditional (such as national sovereign or fiat currencies for example) currencies which may be held in accounts on or controlled by the web server 20, for example. In one such embodiment, at least a portion of the mined electronic currency received by the web server 20 may be converted or exchanged to a traditional cash or fiat currency through a currency market or exchange, for example.

The seventh operation 520 of FIG. 5 comprises the electronic currency web server 20 distributing a portion of the received electronic currency to the organization under the predetermined electronic currency distribution agreement. In one such embodiment, the portion of the mined electronic currency received by the web server 20 to be distributed to the organization as specified by the predetermined distribution agreement for a user or group of user devices may be transferred or assigned to the organization on a batch basis, such as on a weekly, monthly, or other periodic basis, or a continuous basis as mined electronic currency is received, as may be specified in the terms of the distribution agreement agreed by the users of the user devices 10 at the time the application was received, or as agreed between the organization and the owner/operator of the web server 20, for example. In one such embodiment, the remaining portion of the mined electronic currency not transferred to the organization may be distributed or transferred/assigned to the owner or operator of the electronic currency mining web server 20, or their designate, for example. In another embodiment, the electronic currency mining tracking data received by the web server 20 in operation 516 may be stored, such as in electronic currency mining web server storage repository 22, for a period of time, such as to provide for tracking, accounting and compliance verification with the terms of the predetermined electronic currency distribution agreement, for example.

In a further optional embodiment, similar to as described above, at least a portion of the mined electronic currency received by the web server 20 may optionally be converted or exchanged to one or more other electronic or traditional (such as national sovereign or fiat currencies for example) currencies which may be held in accounts on or controlled by the web server 20, for example. In one such optional embodiment, at least a portion of the electronic currency distributed to the third party in operation 520 may comprise a different electronic currency to that mined by the user(s), and in particular at least a portion of the electronic currency distributed to the third party may comprise a traditional sovereign, fiat or cash currency which may be electronically transferred as an electronic cash currency transfer, and/or transferred as a conventional physical payment such as by cheque, bank draft, physical cash payment, or other negotiable financial instrument, for example.

In another optional embodiment, a portion of the mined electronic currency received by the web server 20 from one or more user devices 10 may be distributed to one or more user device or associated user, such as an electronic currency mining participation prize or incentive, for example. In one such optional embodiment, web server 20 may periodically distribute a selected portion of electronic currency (or a selected value in another currency such as fiat or cash currency) mined by a group of user devices 10 to a selected one or several particular user devices 10 or associated users. In one such embodiment, the selected one or several particular user devices 10 or users may be selected randomly, such as in an exemplary case wherein a periodic randomly selected user device 10 or associated user may be allocated a selected portion of electronic currency (or equivalent value) mined by a group of user devices 10 as a monthly (or other periodic) participation lottery, such as to promote participation of users and/or incentivize providing availability of user devices 10 for distributed electronic currency mining according to the above-described systems and methods, for example. In another such optional embodiment, the prize or allocation awarded to a selected one or several particular user devices 10 or associated users may comprise a non-currency prize such as merchandise, vehicle, or service prizes or other suitable incentives, for example.

While the present invention and its various functional components and operational functions have been described in particular exemplary embodiments, the invention may also be implemented in hardware, software, firmware, middleware or a combination thereof and utilized in systems, subsystems, components or subcomponents thereof. In particular embodiments implemented in software, elements of the present invention may be instructions and/or code segments to perform the necessary tasks. The program or code segments may be stored in a machine readable medium, such as a processor readable, such as a processor readable medium or a computer program product, or transmitted by a computer data signal embodied in a carrier wave, or a signal modulated by a carrier, over a transmission medium or communication link. The machine readable medium or processor readable medium may include any medium that can store or transfer information in a form readable and executable by a machine, for example a processor, computer, etc.

An embodiment of the present invention relates to a computer storage product with a computer-readable medium having computer executable code thereon for performing various computer-implemented operations. The computer-readable media and storage products may be non-transitory media and storage, respectively. The computer-readable media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices including Flash RAM memory storage cards, sticks and chips, for example. Examples of computer code include machine code, such as produced by a compiler, and files containing higher-level code that are executed by a computer using an interpreter. For example, an embodiment of the invention may be implemented using HTML, HTML5, XML, JavaScript, Java, C#, C++, Objective C, or other scripting, markup and/or programming languages and development tools. Another embodiment of the invention may be implemented in hardwired circuitry in place of, or in combination with, machine-executable software instructions.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the scope thereof. Accordingly, the scope of the invention is to be construed in accordance with the substance defined by the following claims.

What is claimed is:

1. A computer-implemented method for distributed mining of an electronic currency, comprising executing on at least one computer processor the steps of:
receiving a request from a user electronic device for an electronic currency mining application and an agreement from a user to terms of a predetermined electronic currency distribution agreement;
providing the electronic currency mining application to the user electronic device, wherein the electronic currency mining application comprises a set of computer-readable instructions executable on the user electronic device;
executing the electronic mining application on the user electronic device to mine an electronic currency;
receiving mining tracking data from the user electronic device; and
receiving mined electronic currency from an electronic currency server.

2. The computer-implemented method for distributed mining of an electronic currency according to claim 1, wherein the method additionally comprises executing on at least one computer processor the step of:
distributing a portion of the received electronic currency to a third party according to the predetermined electronic currency distribution agreement.

3. The computer-implemented method according to claim 1, wherein the electronic currency comprises at least one of an electronic cryptocurrency, Bitcoin, Litecoin, Peercoin and Dogecoin electronic currencies.

4. The computer-implemented method according to claim 1, wherein the electronic currency server comprises at least one of an electronic currency server associated with an electronic currency network, and an electronic currency mining pool server.

5. The computer-implemented method according to claim 1, wherein the user electronic device comprises at least one of desktop, portable, handheld, server, and distributed computing resource electronic devices comprising at least one computer processor.

6. The computer-implemented method according to claim 1, wherein mining an electronic currency comprises executing at least one of cryptographic encoding and decoding computations for solving at least a portion of a block of an electronic cryptocurrency system.

7. The computer-implemented method according to claim 1, wherein the agreement from a user to terms of a predetermined electronic currency distribution agreement comprises a user activated link or element in a graphical user interface executing on the user electronic device.

8. The computer-implemented method according to claim 1, wherein the third party comprises a third party electronic device controlled by a third party comprising at least one of an organization, group, foundation or charity.

9. The computer-implemented method according to claim 1, wherein the request from a user electronic device for an electronic currency mining application additionally comprises a request from the user electronic device for another application or service.

10. The computer-implemented method according to claim 1, wherein the electronic currency mining application comprises computer-readable instructions executable to control the user electronic device to mine an electronic currency when the user electronic device is at least one of substantially idle and consuming less than a predetermined percentage of available computing resources of the user electronic device.

11. The computer-implemented method according to claim 1, wherein distributing a portion of the received electronic currency to a third party comprises transferring at least one of a portion of the received electronic currency and an amount of another currency corresponding to the portion of the received electronic currency.

12. The computer-implemented method according to claim 1, wherein the electronic currency mining application comprising a set of computer-readable instructions executable on the user electronic device is storable in a computer-readable memory module of the user electronic device.

13. The computer-implemented method according to claim 12, wherein the computer-readable memory module comprises a non-transitory computer-readable medium.

14. A computer-implemented method for distributed mining of an electronic currency, comprising executing on at least one computer processor the steps of:
providing a link to a user electronic device for a user member of an organization;
receiving from a user electronic device a request from the user activating the link, and an agreement from the user to terms of a predetermined electronic currency distribution agreement to mine electronic currency for the organization;
receiving a request from the user electronic device for an electronic currency mining application;
providing the electronic currency mining application to the user electronic device, wherein the electronic currency mining application comprises a set of computer-readable instructions executable on the user electronic device;
executing the electronic mining application on a user electronic device to mine an electronic currency;
receiving mining tracking data from the user electronic device; and
receiving mined electronic currency from an electronic currency server.

15. The computer-implemented method for distributed mining of an electronic currency according to claim 14, wherein the method additionally comprises executing on at least one computer processor the step of:
distributing a portion of the received electronic currency to the organization according to the predetermined electronic currency distribution agreement.

16. The computer-implemented method according to claim 14, wherein the electronic currency comprises at least one of an electronic cryptocurrency, Bitcoin, Litecoin, Peercoin and Dogecoin electronic currencies.

17. The computer-implemented method according to claim 14, wherein the electronic currency server comprises at least one of an electronic currency server associated with an electronic currency network, and an electronic currency mining pool server.

18. The computer-implemented method according to claim 14, wherein the user electronic device comprises at least one of desktop, portable, handheld, server, and distributed computing resource electronic devices comprising at least one computer processor.

19. The computer-implemented method according to claim 14, wherein mining an electronic currency comprises executing at least one of cryptographic encoding and decoding computations for solving at least a portion of a block of an electronic cryptocurrency system.

20. The computer-implemented method according to claim 14, wherein the agreement from a user to terms of a predetermined electronic currency distribution agreement comprises a user activated link or element in a graphical user interface executing on the user electronic device.

21. The computer-implemented method according to claim 14, wherein the electronic currency mining application comprises computer-readable instructions executable to control the user electronic device to mine an electronic currency when the user electronic device is at least one of substantially idle and consuming less than a predetermined percentage of available computing resources of the user electronic device.

22. The computer-implemented method according to claim 14, wherein distributing a portion of the received electronic currency to the organization comprises transferring at least one of a portion of the received electronic currency and an amount of another currency corresponding to the portion of the received electronic currency.

23. The computer-implemented method according to claim 14, wherein the electronic currency mining application comprising a set of computer-readable instructions executable on the user electronic device is storable in a computer-readable memory module of the user electronic device.

24. The computer-implemented method according to claim 23, wherein the computer-readable memory module comprises a non-transitory computer-readable medium.

25. A system for distributed mining of an electronic currency, the system comprising:
one or more network interfaces;
at least one computer processor;
a computer-readable memory module; and
computer-readable instructions stored in the computer-readable memory module, wherein the computer-readable instructions when executed, are operable to configure the at least one computer processor to:
receive a request from a user electronic device for an electronic currency mining application and an agreement from a user to terms of a predetermined electronic currency distribution agreement;
provide the electronic currency mining application to the user electronic device;
execute the electronic mining application on a user electronic device to mine an electronic currency;
receive mining tracking data from the user electronic device; and
receive mined electronic currency from an electronic currency server.

26. The system for distributed mining of an electronic currency according to claim 25, additionally comprising computer-readable instructions stored in the computer-readable memory module, wherein the computer-readable instructions when executed, are operable to configure the at least one computer processor to:
distribute a portion of the received electronic currency to a third party according to the predetermined electronic currency distribution agreement.

27. The system for distributed mining of an electronic currency according to claim 25, wherein the computer-readable memory module comprises a non-transitory computer-readable medium.
